(19) United States
(12) Patent Application Publication
(10) Pub. No.: US 2012/0186098 A1
(43) Pub. Date: Jul. 26, 2012

(54) DRYER FOR BOMB DISPOSAL SUITS

(75) Inventor: Gary Williams, Langley (CA)

(73) Assignee: Williams Boot & Glove Dryers Inc.

(21) Appl. No.: 13/339,938

(22) Filed: Dec. 29, 2011

Related U.S. Application Data
(60) Provisional application No. 61/431,969, filed on Jan. 12, 2011.

(51) Int. Cl. F26B 25/20

(52) U.S. Cl. 34/240

(57) ABSTRACT

A readily assembled and disassembled portable forced air dryer system for bomb disposal suits having a subassembly of a blower/heater housing and air discharge manifold and releasably attached support members with removable rollers, which may be castered. A first riser rack with tubes ported for air discharge and a baseplate is releasably assembled to the manifold for effecting forced air drying of pants for the suit received on the rack. A second riser rack with tubes ported for air discharge and a baseplate is releasably assembled to the manifold for effecting forced air drying of a jacket and helmet of the suit. The subassembly, first and second rack, support members may be disassembled, packaged and transported with assembly fasteners as a kit.

This application claims the benefit of priority to U.S. Provisional Application No. 61/431,969, filed Jan. 12, 2011, entitled “Dryer for Bomb Disposal Suits,” by Gary Williams, which is hereby incorporated by reference in its entirety.

### BACKGROUND

Protective garments worn by personnel charged with disposal of bombs and explosive devices are by their very nature heat insulating, bulky and heavy. Typically, such garments or suits comprise pants, a jacket, groin armor or “diaper” and helmet with face mask. In view of the nature of the usage and construction of such suits, it is necessary that after each usage they are forced air dried to prevent growth of fungus and mold and for preservation and sanitation purposes. In view of the weight and bulk of such suits, which with helmet weight about 70 pounds, ordinary drying racks designed for first responder protective garments such as, for example, those worn by firefighters, are not designed for the weight of a bomb disposal suit or adequately configured for adequate drying air distribution of such a suit.

It has thus been desired to provide a dryer for bomb disposal suits which is adequately constructed to handle the weight and bulk of the suit and which, when dressed, is readily portable to permit transport to an area equipped with electrical power supply for the dryer and subsequently to a storage area.

Furthermore, in view of the bulk or size of the dryer and rack required for drying bomb disposal suits, it has been desired to provide such a system which is compact when boxed for shipment to a remote site for quick assembly and usage.

### BRIEF DESCRIPTION

The bomb disposal suit dryer described in the present disclosure employs a heater/dryer/air distribution manifold subassembly to which is readily attached separate pairs of vertical riser members extending upwardly therefrom in cantilever or free standing onto which the individual garments or portions of the bomb disposal suit may be dressed. The system of the present disclosure employs one type of free standing vertical rack pair suited for the pants of the bomb disposal suit with interconnecting cross piece and arcuate diffuser and a second adjacent vertical rack pair with arms and spherical top suitable for hanging and drying the jacket and helmet. The combination heater/dryer/manifold is supported by a support structure, disclosed in one version as a pair of beams which are readily attached thereto by the user and which beams are in turn supported on rollers or castors for ease of transport. If desired, an additional low riser rack having a pair of vertical supports and interconnecting piece with diffuser may be attached to the manifold for providing forced air drying of the “diaper.” The drying system of the present disclosure is thus uniquely configured for the bulk and weight of forced air drying bomb disposal suits and yet may be packaged and shipped to the user in a disassembled state and readily and easily assembled on site by the user with minimal tools.

### BRIEF DESCRIPTION OF THE DRAWINGS

FIG. 1 is a perspective view of the dryer system of the present disclosure with a bomb disposal suit in dashed outline disposed thereon for forced air drying;

FIG. 2 is a perspective front view of the system of FIG. 1;

FIG. 3 is a perspective view of the drying system of FIG. 1 with the bomb disposal suit removed;

FIG. 4 is a perspective view of the combination dryer/heater/manifold subassembly of the system of FIG. 1 prior to assembly;

FIG. 5 is a perspective view of one of the pair of support beams employed in the system of FIG. 1;

FIG. 6 is a section view taken along section indicating lines 6-6 of FIG. 5;

FIG. 7 is a perspective view of one of the pair of vertical riser tubes employed for drying the pants in the system of FIG. 1 prior to assembly;

FIG. 8 is a perspective view of one of the pair of vertical riser tubes for drying the jacket in the system of FIG. 1 prior to assembly

FIG. 9 is a perspective view of the top cross piece for he riser tubes of FIG. 8;

FIG. 10 is a perspective view of the helmet support sphere for the member of FIG. 9;

FIG. 11 is a perspective view of the underside of the cross piece for a pair of riser tubes of FIG. 7;

FIG. 12 is a perspective view of the arcuate diffuser for attachment to the cross piece of FIG. 11 prior to assembly;

FIG. 13 is an underside view of the manifold/dryer/heater as attached to the support beams of FIG. 5 with casters installed;

FIG. 14 is a perspective view from the front of the assembly of FIG. 13;

FIG. 15 illustrates typically the assembly of one the of vertical free standing risers to the assembly of FIG. 14;

FIG. 16 illustrates the assembly of the cross piece of FIG. 9 to the jacket dryer vertical risers of FIG. 8;

FIG. 17 shows the installation of the spherical helmet support on the cross piece of FIG. 9;

FIG. 18 shows the cross piece of FIG. 11 and the arcuate diffuser member of FIG. 12 prior to assembly;

FIG. 19 shows the cross piece and diffuser of FIG. 18 in the assembled position on the vertical risers;

FIG. 20 shows the system of FIG. 1 with an optional additional free standing rack with arcuate diffuser for drying the diaper; and,

FIG. 21 shows the system of FIG. 20 with the diaper in dashed line in dressed position for drying.

### DETAILED DESCRIPTION

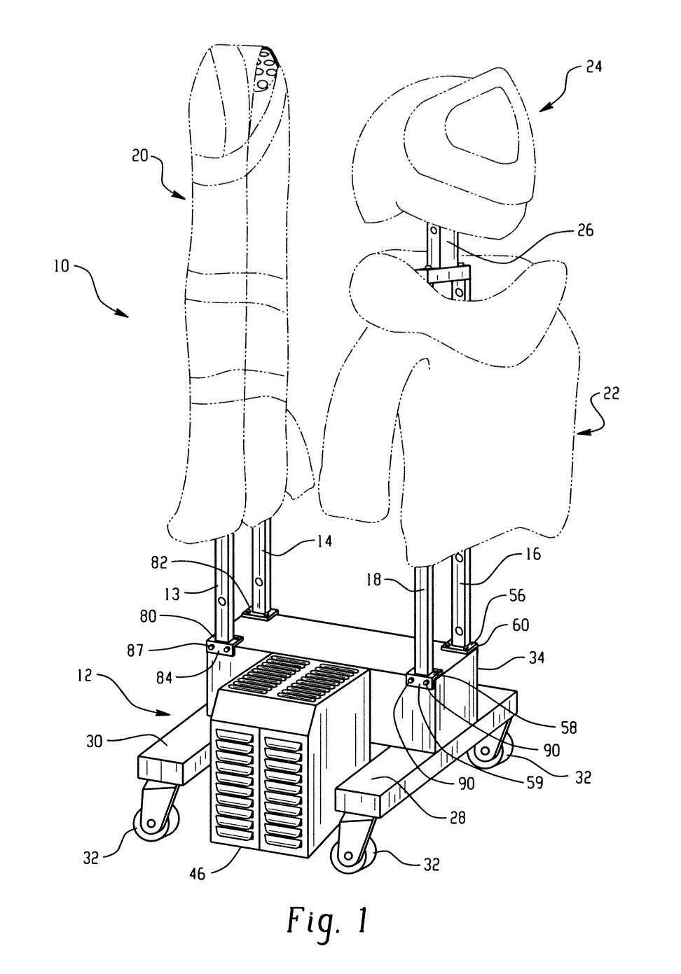

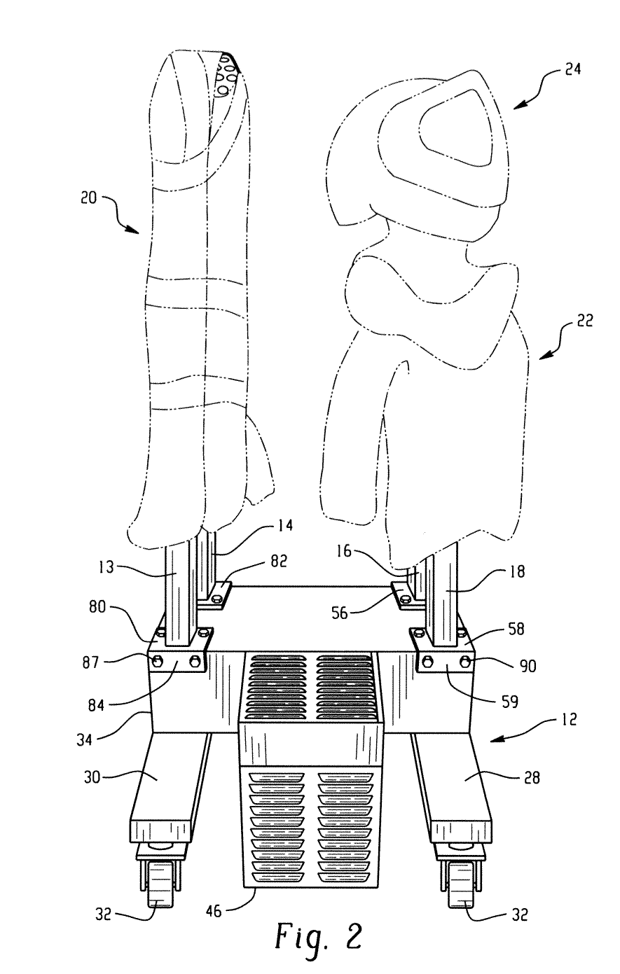

Referring to FIGS. 1 and 2, the dryer system of the present disclosure is indicated generally at 10 and includes a combination heater/dryer/manifold subassembly indicated generally at 12 with free standing uprights or vertical tubes 13, 14, 16, 18 dressed with and supporting the garments of a bomb disposal suit. The suit is shown in dashed line as comprising pants indicated generally at 20 disposed over tubes 13, 14, a jacket indicated generally at 22 disposed over tubes 16, 18 and a helmet indicated generally at 24 supported on a member 26 attached to uprights 16, 18. Subassembly 12 is supported by support beams 28, 30 which are each provided with a pair of rollers or casters denoted by reference numeral 32.

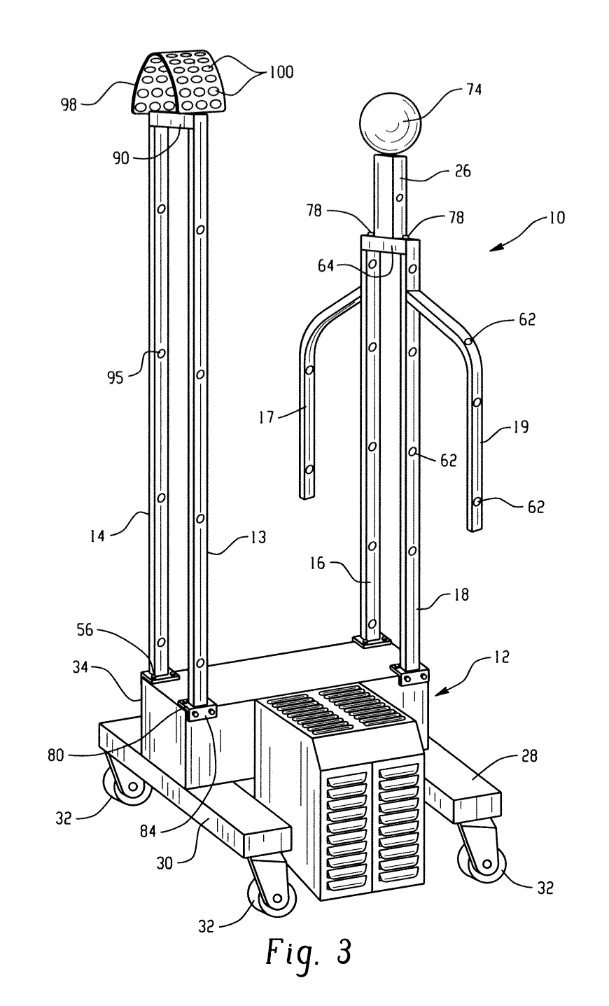

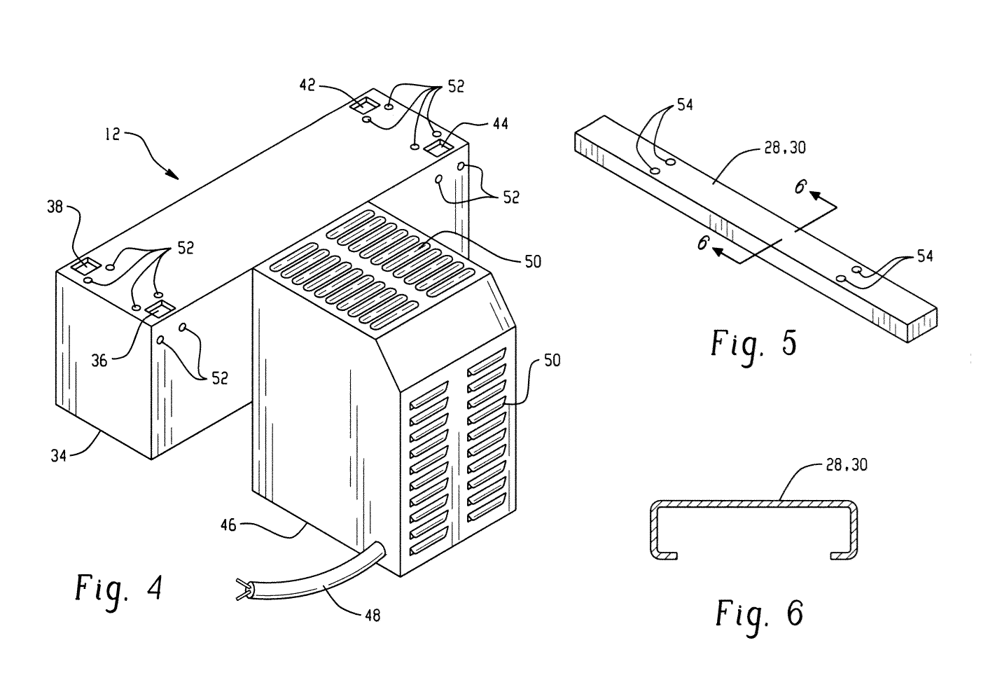

Referring to FIGS. 3 and 4, the system 10 of FIG. 1 is shown with the suit garments removed and shows the heater/blower/manifold subassembly 12 as comprising an air distribution manifold 34 shown separately in FIG. 4 having a plurality of air outlets 36, 38 formed in the top adjacent one end for providing air flow through the riser tubes 13, 14. The manifold 34 has a second pair of air outlet ports 42, 44 provided adjacent the manifold end opposite for providing air flow to the vertical tubes 16, 18. The subassembly 12 has a housing 46 attached to the manifold which housing contains a blower (not shown) and a heater (not shown) which discharge air into the manifold for distribution through outlets 36, 38, 42, 44. A power cord 48 is provided thereon for connection to a source of electrical power (not shown). The housing 46 is provided with a plurality of louvered slots denoted by reference numeral 50 for providing a supply of air to the blower within. Each of the outlet holes 36, 38 and 42, 44 has provided on the top and sides of the manifold, a plurality of internally threaded holes 52 disposed thereabout for attachment of the riser tubes to the top of the manifold. If desired, the threaded holes may be provided by inset nuts attached to the underside of the top and sides of the manifold.

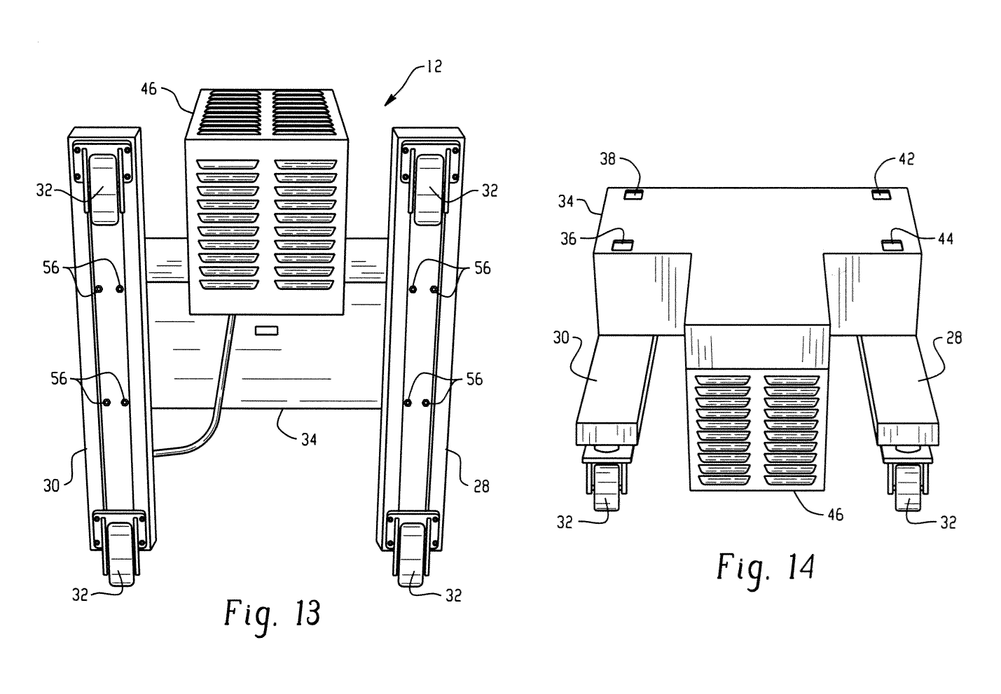

Referring to FIGS. 5 and 6, the support beams 28, 30 are illustrated typically; and, as shown in FIG. 6, have a generally C-shaped configuration which may, if desired, be fabricated of formed sheet material. The support beams 28, 30 each have a plurality of apertures 54 provided therein through which attachment bolts, such as bolts 56 (see FIG. 13) are received for engaging internally threaded apertures (not shown) in the undersurface of manifold 34.

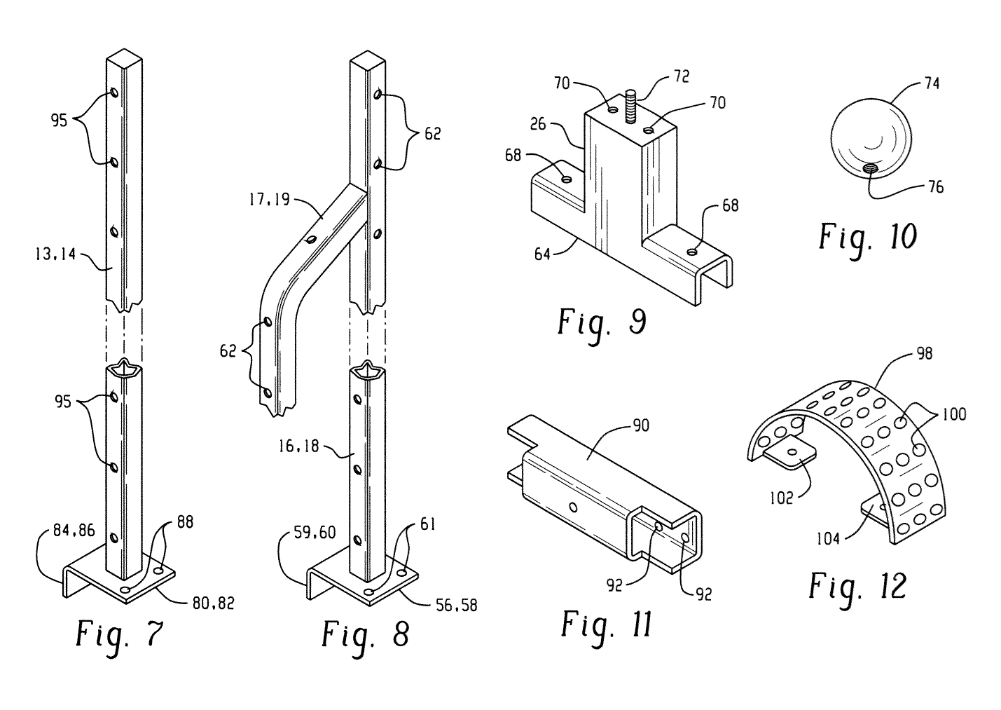

Referring to FIG. 7, the risers for the pants are shown typically at 13, 14 and each has respectively a base plate 80, 82 attached thereto such as by weldment; and, in the illustrated exemplary version, each of the base plates 80, 82 has a flange formed at right angles therewith as denoted respectively by reference numerals 84, 86, which flange, upon assembly, extends over the side of the manifold. The flanges 84, 86 and the plates 80, 82 are each provided with apertures 88 for attachment of bolts therethrough for engaging the internally threaded apertures 52 provided in the manifold. Each of the riser tubes 13, 14 is provided with a plurality of spaced holes or apertures denoted by reference numeral 95 spaced therealong for providing discharge air flow ports for drying the interior of the jacket. It will be understood that the base plates 80, 82 have unshown apertures therethrough corresponding to apertures 36, 38 on the top of the manifold to communicate discharge air upward through the riser tubes.

The base plates 80, 82 each have apertures 88 provided therein for receiving therethrough fasteners, such as bolts 90, for releasably securing the base plate to the top of the manifold (see FIG. 1).

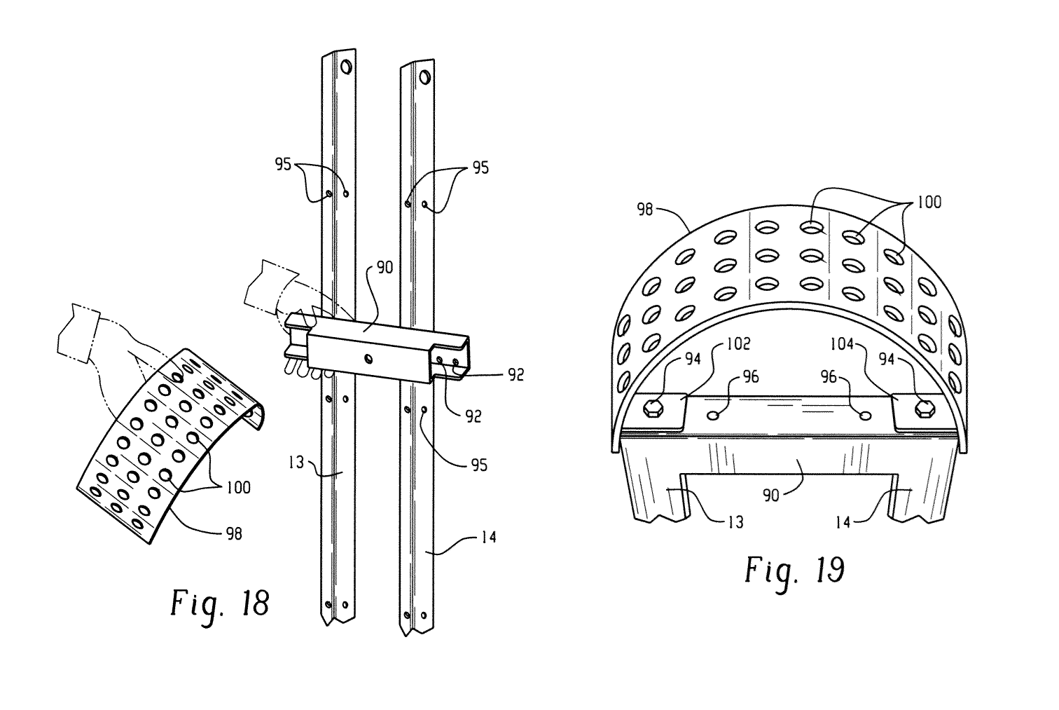

Referring to FIGS. 11, 12, 18 and 19, the risers 13 and 14 are connected at the top by a cross piece 90 which has a tubular configuration with the wall on the bottom side cut away at the ends thereof to permit the cross piece to fit over the upper ends of the risers 13, 14. The cross piece 90 has apertures 92 formed in the upper side thereof adjacent the ends for receiving fasteners therethrough, such as bolts 94, which engage internally threaded apertures (not shown) provided in the risers 13, 14. It will be understood that the risers 13, 14 are also provided with air distribution apertures 95 disposed therealong. The cross piece 90 also has air distribution holes 96 formed in the upper surface thereof for directing a flow of discharge air upward.

Referring to FIGS. 3, 12, 18 and 19, an arcuate diffuser member 98 has a plurality of air distribution holes 100 provided therethrough and has, at each end thereof, a mounting tab 102, 104, each of which has an aperture therethrough for receiving therethrough one of the bolts 94 (see FIG. 19) for retaining the arcuate diffuser 98 and the cross piece 92 to the vertical tubes 13, 14.

Referring to FIG. 8, the riser tubes 16, 18 for the jacket are each respectively provided with a downwardly extending arm respectively 17, 19 for supporting the shoulder and sleeve of the jacket 22. Riser tubes 16, 18 are also provided with base plates 56, 58 with edge flanges 59, 60 and apertures 61 on the plates and edge flanges for attachment over manifold apertures 52 and releasably bolting thereon. It will be understood that base plates 56, 58 are provided with unshown apertures therethrough corresponding to manifold apertures 42, 44 for providing airflow up the risers 16, 18.

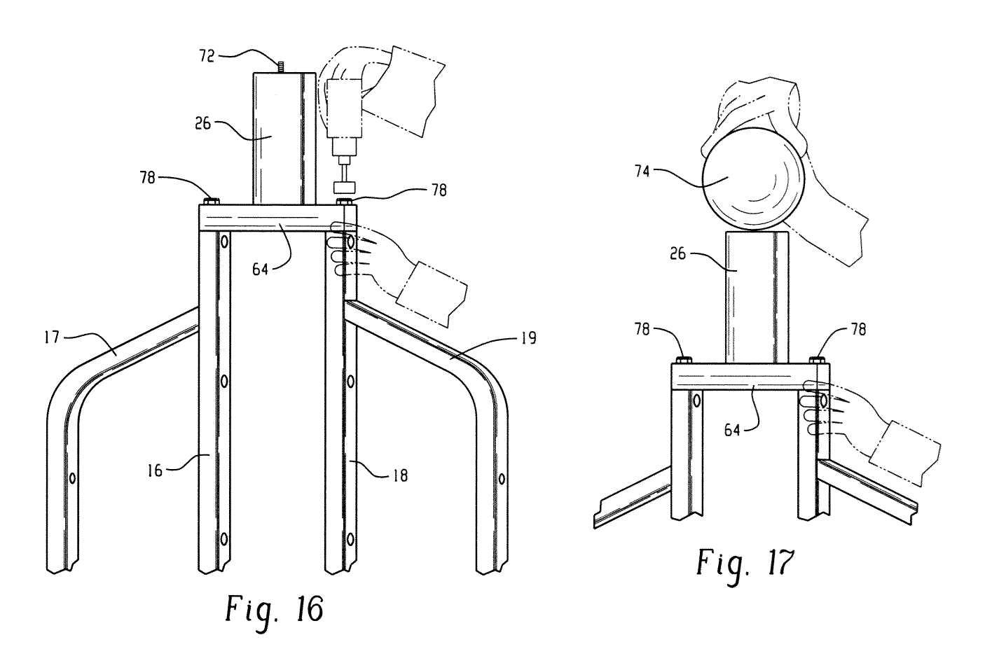

Referring to FIGS. 8, 9 and 16, the tubular helmet riser tube 26 is attached such as by weldment at its base to a tubular cross piece 64 which has the ends thereof cut away along one side to permit assembly over the top of the risers 16, 18 and has internally threaded apertures provided in the upper end of the tubes 16, 18; and, the cross piece 64 has apertures 68 formed in the top side thereof adjacent each end thereof for attachment to the risers 16, 18. The top of the hollow riser tube 26 has a pair of discharge air flow apertures 70 provided thereon and has an upstanding threaded stud 72 provided thereon for attachment of the spherical helmet support member 74 (see FIG. 10) which has an internally threaded aperture 76 provided therein for threaded engagement of the stud 72. The cross piece 64 is secured over the ends of the vertical tubes 16, 18 by suitable threaded fasteners such as bolts 78 as shown in FIG. 3 and FIG. 16.

Referring to FIG. 13, the initial step of assembly of the components shipped as shown in FIGS. 4-12, is begun by attaching the support beams 28, 30 to the undersurface of the manifold 34 by bolts 56 thereby providing the subassembly indicated in FIG. 14. The casters 32 are attached to the flanges of the underside of the C-shaped or channel beams by machine screws or bolts engaging recessed threaded fasteners, such as inset nuts provided on the inside of the beams.

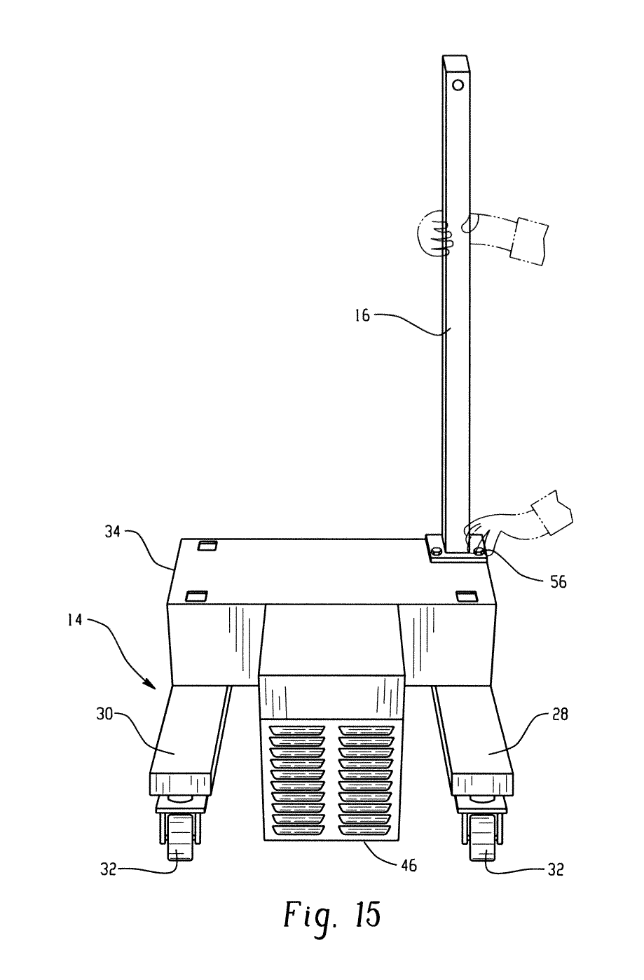

Referring to FIG. 15, the riser tubes 16, 18 are releasably attached to the upper surface of the manifold by bolts, such as bolts 56 and 90 shown in FIG. 1, engaging unshown inset threaded fasteners in the manifold holes 52. The riser tubes 16, 18 are aligned over the discharge air flow apertures 42, 44 provided in the upper surface of the manifold 34.

Referring to FIG. 16, the tubular cross piece 64 with helmet tubular riser 26 is then attached to the upper ends of the riser 16, 18 by bolts 78.

Upon attachment of the tubular cross piece 64 and riser tube 26, the helmet sphere 74 is then assembled onto the threaded fastener at the top of the riser 26 as shown in FIG. 17.

Referring to FIGS. 1, 2 and 3, the riser tubes 13, 14 for the pants are releasably attached to the manifold over the air flow apertures 36, 38 on the upper surface of the manifold by fasteners, such as bolts 87, received through the base plates 80, 82 and the flanges 84, 86. The cross piece 90 and the tabs 102, 104 of the arcuate member 98 are then secured to the upper ends of the tubes 13, 14 by bolts 94.

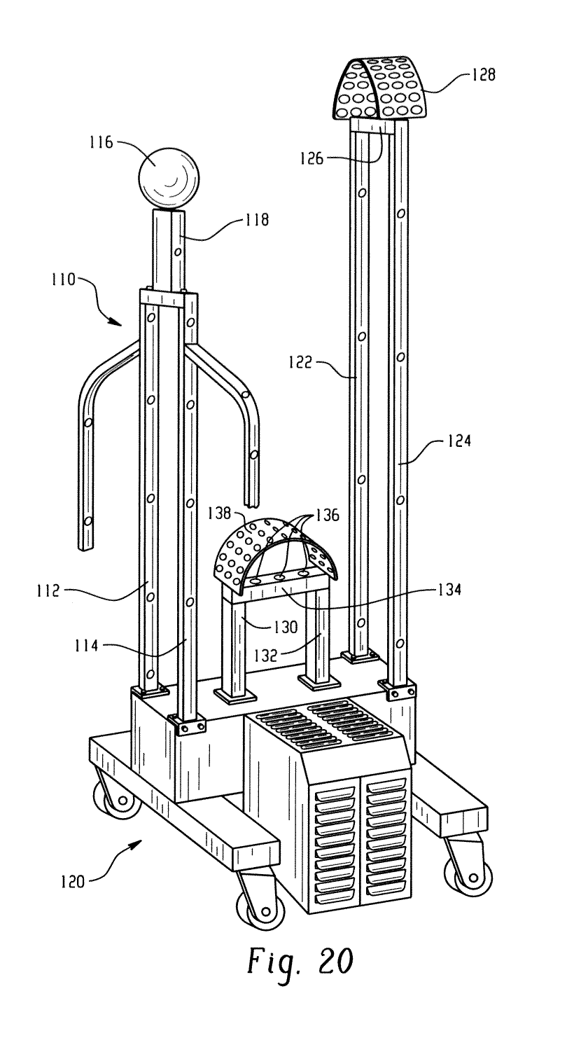

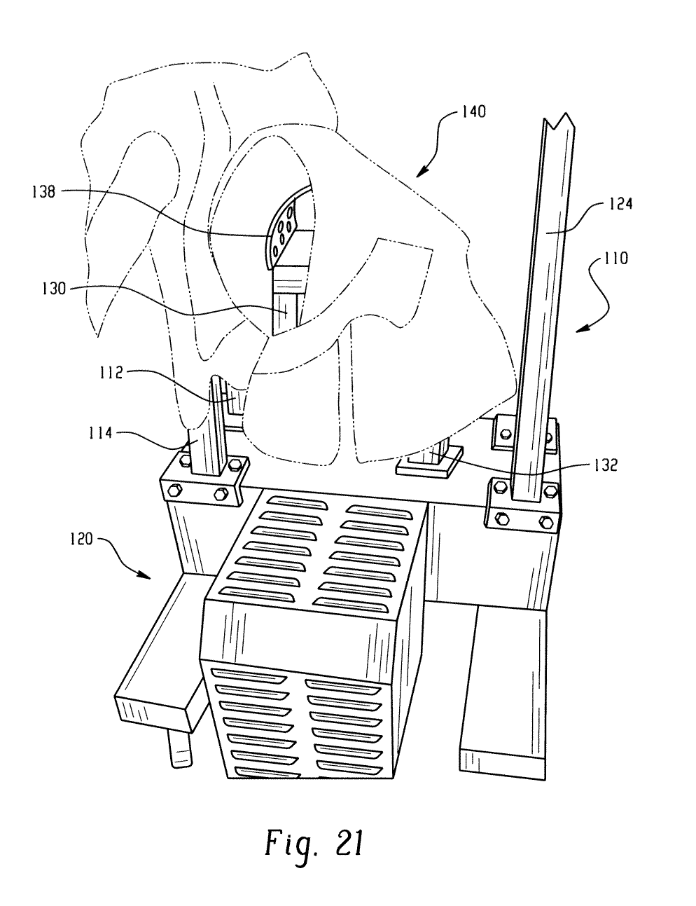

Referring to FIGS. 20 and 21, another version of a bomb disposal suit drying system indicated generally at 110 is shown as having a pair of free standing riser tubes 112, 114 similar to tubes 16, 18 of the embodiment 10 with a helmet ball 116 provided on the upper end of a riser 118. The risers are connected by base plates to a heater/blower/manifold subassembly 120 which may be similar to the subassembly 12 of the embodiment of FIG. 1. The system 110 has a second pair of free standing riser tubes 122, 124 disposed on the end of the manifold opposite the tubes 112, 114 and the tubes 122, 124 are connected at the top by tubular cross piece 126 and have an arcuate diffuser 128 for receiving thereover the straps of the bomb disposal suit pants.

In the version 110, a third relatively short riser having a pair of tubular members denoted 130, 132 is attached to the upper surface of the manifold between the pants and jacket risers. In the illustrated exemplary version, the risers 130, 132 are relatively much shorter, only a fraction of the height of the first and second riser tubes. The tubes 130, 132 are connected by a tubular cross piece 134 and which has air holes 136 therein for providing discharge dryer air upwardly to an arcuate diffuser 138. The diffuser 138 may be configured similar to the diffuser 98 of the embodiment of FIG. 1. The riser tubes 130, 132 are utilized for drying and supporting a portion of the bomb disposal suit referred to as the “diaper” indicated generally at 140 and which is configured for protecting the groin area of the user. The “diaper” 140 is shown in dashed line dressed or installed over the tubes 130, 132 in FIG. 21.

In the present practice it has been found satisfactory to provide all internal threaded holes with threads accommodating standard or common ¼″ threaded bolts.

The readily and easily disassembled knock-down drying system of the present disclosure thus provides a unique configuration for a bomb disposal suit as a portable unit which has a self contained blower, heater and air distribution manifold providing a flow of drying air to the risers or rack tubes. The system of the present disclosure is conveniently mounted on rollers or castors to provide transportability with ease despite the substantial weight of the bomb disposal suit when received thereon. The system may be packaged and shipped to the end user at a remote site in a disassembled or knocked-down state thereby minimizing package volume. The unit is then readily and easily assembled on site by the user with a minimum of tools.

Exemplary versions have been described with reference to the drawings. Obviously, modifications and alterations will occur to others upon reading and understanding the preceding detailed description. It is intended that the exemplary versions be construed as including all such modifications and alterations.

1. A drying system for a bomb disposal suit having pants, jacket and a helmet comprising:
(a) a subassembly including a blower, heater and air discharge manifold;
(b) support structure including rollers, the support structure attached to the subassembly;
(c) a first free standing riser releasably attached to the manifold for supporting the pants of the suit for drying; and,
(d) a second free standing riser releasably attached to the manifold for supporting the jacket and the helmet of the suit, wherein the first and second riser include a conduit communicating with the manifold for effecting forced air drying.

2. The system defined in claim 1, wherein the support structure includes releasably attached rollers.

3. The system defined in claim 1, wherein the support structure is releasably attached to the subassembly.

4. The system defined in claim 1, wherein the first and second riser include a pair of spaced tubular members with air discharge ports and a baseplate for attachment to the manifold.

5. The system defined in claim 4, wherein the tubular members comprise the conduit.

6. The system defined in claim 1, wherein the support structure is releasably attached to the subassembly.

7. The system defined in claim 1, wherein the first riser member includes a perforated curved member for supporting shoulder straps of the pants.

8. The system defined in claim 1, wherein the second riser includes a spherical member for supporting the helmet.

9. The system defined in claim 1, wherein the second riser includes a pair of spaced tubular members each having a tubular arm extending therefrom for drying a sleeve of the jacket.

10. The system defined in claim 1, further comprising a third riser rack including a conduit connected for discharging air from the manifold and adapted for drying a diaper portion of the suit.

11. The system defined in claim 10, wherein the third riser rack is disposed intermediate the first and second riser rack.

12. The system defined in claim 1, wherein the support structure includes a pair of spaced beam members.

13. The system defined in claim 12, wherein each of the pair of beam members has a pair of rollers attached thereto.

14. The system defined in claim 13, wherein one of the pair of rollers is castered.

15. The system defined in claim 1, wherein the support structure includes a pair of spaced beams having a channel section.

16. A kit for assembling a drying system for a bomb disposal suit having pants, jacket and a helmet comprising:
(a) a subassembly comprising a blower, heater and air discharge manifold;
(b) a first riser rack attachable to the manifold including a conduit for air drying the pants;
(c) a second riser rack attachable to the manifold including a conduit for air drying the jacket and helmet;
(d) a pair of support members for the subassembly;
(e) a plurality of rollers for attachment to the support members; and,
(f) a plurality of threaded fasteners for releasably attaching the risers and support members to the manifold, and the rollers to the support members.

17. The kit of claim 16, wherein the first and second riser racks include a pair of spaced tubular members with air discharge ports and a baseplate for attachment to the manifold.

18. The kit of claim 16, wherein the second riser rack includes a spherical member for supporting the helmet.

19. The kit of claim 16, wherein the first riser rack includes a curved perforated member for supporting shoulder straps of the pants.

20. The kit of claim 19, wherein the curved perforated member is releasably attached with the threaded fasteners.

21. The kit of claim 16, wherein the support members comprise a pair of beams.

22. The kit of claim 16, wherein the beams have a channel cross section.

23. The kit of claim 16, wherein the support members comprise a pair of beams, each with a pair of the rollers.

24. The kit of claim 23, wherein one of the pair of rollers is castered.
